(19) United States
(12) Patent Application Publication
(10) Pub. No.: US 2017/0311616 A1
(43) Pub. Date: Nov. 2, 2017

(54) ATMOSPHERIC PRESSURE CONTROL SYSTEM

(71) Applicant: Storage Control Systems, Inc., Sparta, MI (US)

(72) Inventors: James C. Schaefer, Rockford, MI (US); Andrew L. Klipa, Grand Rapids, MI (US); Daniel E. Boozer, Rockford, MI (US); Michael C. Laraway, Grand Rapids, MI (US); Bryan D. Cook, Cedar Springs, MI (US)

(21) Appl. No.: 15/141,915

(22) Filed: Apr. 29, 2016

(51) Int. Cl. A23B 7/148; F24F 11/00; F24F 13/08

(52) U.S. Cl. CPC A23B 7/148; F24F 11/0015; F24F 11/0079; F24F 11/0012; F24F 2011/0028; F24F 2011/0042; F24F 2013/087; F24F 2011/0026

(57) ABSTRACT

A pressure control system for a CA room including a bladder and an active displacement control that are operable to control the internal pressure of the CA room through variations in displacement. The system may include a controller configured to vary the displacement of the bladder based on the difference between barometric pressure and CA room internal pressure. The system may control bladder displacement based on the output of a differential pressure sensor that measures the pressure differential between the CA room and barometric pressure, or the output of separate internal and external sensors that separately measure CA room pressure and barometric pressure. The bladder may be an inflatable bladder and the active displacement control may inflate and deflate the bladder to vary its displacement within the CA room. The active displacement control may include an active air supply with a blower that can quickly inflate and deflate the bladder.

### BACKGROUND OF THE INVENTION

The present invention relates to controlled atmosphere (CA) storage, and more particularly to systems for controlling atmospheric pressure in controlled atmosphere storage room.

Controlled atmosphere rooms are commonly used to store fruits, vegetables and other commodities that benefit from storage in a controlled environment. Conventional controlled atmosphere rooms typically provide the ability to control both temperature and atmospheric gas mixture, such as oxygen (O2) and carbon dioxide (CO2) levels.

Even the most leaktight controlled atmosphere rooms can be affected by barometric pressure changes. For example, changes in barometric pressure can increase the pressure differential between the atmosphere within the CA room and the atmosphere in the surrounding environment. The increase in pressure differential can increase the impetus for air to flow between the atmosphere and the CA room, which may in turn create new leaks or increase air flow through existing leaks in the CA room. To illustrate, when barometric pressures increases, it has the potential to create a significant level of negative pressure inside the CA room. The increase in pressure differential increases the forces urging atmospheric gases to flow into the CA room. As a result, new leaks can be formed and existing leaks can be increased.

A number of systems have been developed to address pressure issues in CA rooms. For example, some CA rooms are provided with pressure relief valves that allow gases to vent from the CA room when the pressure in the CA room goes sufficiently positive or negative. There are also passive air bag systems that include a large air bag situated outside or inside the CA room in a location that is subject to barometric pressure. The passive air bag is in fluid communication with the atmosphere in the CA room, for example, by a large diameter pipe. As barometric pressure changes over time, relative differences in pressure between the room and the outside environment cause air to passively flow between the CA room and the passive air bag. For example, when barometric pressure increases, it causes the external air bag to contract, thereby moving air from the air bag into the CA room. Likewise, when barometric pressure decreases, pressure inside the CA room becomes positive and air moves from the room into the air bag.

### SUMMARY OF THE INVENTION

The present invention provides a pressure control system for a CA room. The pressure control system includes a bladder and active displacement control that are operable to control the internal pressure of the CA room through variations in displacement. In one embodiment, the system includes a controller configured to vary the displacement of the bladder based on a comparison between barometric pressure and the internal pressure of the CA room. The system may include a first pressure sensor located outside the CA room to sense barometric pressure and a second pressure sensor located inside the CA room to measure internal room pressure.

In one embodiment, the pressure control system may include an inflatable bladder and the active displacement control may inflate or deflate the bladder to vary its displacement within the CA room. For example, the bladder may be inflated to occupy a greater volume within the CA room, thereby reducing the volume occupied by the atmosphere of the CA room. As a result, inflating the bladder increases the internal pressure of the CA room. Similarly, the bladder may be deflated to occupy less volume within the CA room, thereby increasing the volume occupied by the atmosphere of the CA room and decreasing the internal pressure of the CA room.

In one embodiment, an inflatable bladder is coupled to an active air supply so that it can be quickly inflated and deflated in response to changes in barometric pressure. For example, the active air supply may be a blower or a supply of compressed gas. The active air supply may operate to supply air to the bladder when negative pressure exists in the CA room (e.g. pressure inside the CA room is lower than barometric pressure) or to vent air from the bladder when positive pressure exists in the CA room (e.g. pressure inside the CA room is higher than barometric pressure). The active displacement control may be configured to repeatedly compare barometric pressure and internal pressure and to make appropriate adjustment to the bladder to maintain the desired pressure differential between the CA room and the barometric pressure. The timing between successive measurements and bladder adjustments may vary from application to application. For example, the process may be repeated as quickly as possible or the process may be repeated at fixed time intervals, such as any number of seconds or any number of minutes. The active displacement control may be configured to maintain a relatively small positive pressure in the CA room to reduce the risk of extraneous air entering into the CA room and negatively affecting the gas mixture.

In one embodiment, the pressure control system includes one or more modular bladders that can be selectively coupled to the active displacement control. The number of modular bladders disposed in a CA room may be varied in proportion to the internal volume of the CA room. When inflatable bladders are used, the bladders and related pipework may include quick connect fittings that allow a plurality of bladders to be joined to one another and/or to the pipework. In some embodiments, a plurality of modular inflatable bladders may be coupled to a single active air supply, such as a single blower. In other embodiments, the pressure control system may include a plurality of active air supplies that are capable of operating in concert to simultaneously inflate and deflate one or more bladders. Multiple active air supplies may be beneficial when it is desirable to inflate/deflate the bladder(s) at a faster rate.

In one embodiment, the bladders are configured to be fitted into the void air space between bin stacks and the walls of the CA room. In this embodiment, the bladders may be configured to fit closely to the walls to minimize their impact on usable storage space within the CA room.

In one embodiment, the bladders are contained in rigid storage bins that can be stacked within the CA room. When the bladders are inflatable, the bins may include quick connect fittings that allow then to be quickly coupled together in a modular manner.

In one embodiment, the bladder(s) may be positioned in a separate room or separate space that is in fluid communication with the CA room, such that inflation and deflation of the bladder impacts that overall volume of the CA room. The separate space may be adjacent to the CA room, such as an attic or cupola, or it may be spaced apart from and joined to the CA room by an air flow passage, such as a pipe.

As an alternative to an inflatable bladder, the bladder may be essentially any structure or mechanism that is capable of providing variable displacement. For example, the bladder may include a movable wall that is disposed within the CA room and is movable to adjust the internal volume of the CA room. As another example, the bladder may include an arrangement of bellows that can be articulated to vary displacement. In another example, the bladder may include a large cylinder and piston arrangement in which the piston can be moved within the cylinder to vary displacement. In yet another example, the CA room may include a liquid reservoir that can be filled with varying amounts of liquid (e.g. water) to vary displacement.

In one embodiment, the system may include an internal bladder contained in the CA room and an external bladder disposed outside the CA room. The two bladders may be coupled so that air is free to flow between the two bladders. In use, the internal bladder may be subject to the internal pressure of the CA room and the external bladder may be subject to barometric pressure in the environment outside the CA room. As such, pressure differentials between the internal bladder and the external bladder may move air between the two bladders to equalize the internal pressure of the CA room with the barometric pressure.

The present invention provides simple and effective pressure control system that reduces CA room leaks by allowing rapid variation in internal CA room pressure relative to external (or barometric) pressure. The present invention can be implemented with an inflatable bladder or with other types of bladders that provide variable displacement. When an inflatable bladder is used, an active air supply, such as a blower or supply of compressed air, allows for rapid variation in CA room pressure. A controller may be provided to monitor internal CA room pressure and barometric pressure, and to adjust the bladder based on differences therebetween. The bladder may be suspended from the wall or the ceiling in a location that minimizes impact on available storage space. The bladder may be disposed in a storage bin or similar rigid housing that provides a reserved space for inflation and deflation of the bladder. The system may incorporate modular bladders so that it can be readily adapted for use in CA rooms of different sizes. Quick connect fittings may be used to facilitate installation and removal of one or more modular bladders.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a diagrammatic representative view of a CA room incorporating a pressure control system in accordance with an embodiment of the present invention showing a mostly deflated bladder.

FIG. 2 is a diagrammatic representative view of a CA room similar to FIG. 1, but with the bladder fully inflated.

FIG. 3 is a diagrammatic representative view of the CA room incorporating an alternative embodiment of the pressure control system with a plurality of modular bladders.

FIG. 4 is a diagrammatic representative view of the CA room of FIG. 4 showing an alternative connection between modular bladders.

FIG. 5 is an enlarged, exploded view of the bladder and pipework showing quick connect fittings.

FIG. 6 is a diagrammatic representation view of the CA room with an alternative bladder disposed in an attic space.

FIG. 7 is a diagrammatic representation view of the CA room with an alternative bladder with an elongated configuration.

FIG. 8 is a diagrammatic representation view of the CA room with an alternative bladder with a piston configuration.

FIG. 9 is a diagrammatic representation view of the CA room with an alternative bladder with a movable wall.

FIG. 10 is a diagrammatic representation view of the CA room with an alternative bladder with a bellows configuration.

FIG. 11 is a diagrammatic representation view of the CA room with an alternative bladder with a liquid reservoir.

FIG. 12 is a diagrammatic representation view of the CA room with an alternative bladder with an alternate liquid reservoir.

FIG. 13 is a diagrammatic representation view of the CA room with another alternative pressure control system having a plurality of bladders contained in modular storage bins joined in series with quick connect fittings.

FIG. 14 is a diagrammatic representation view of the CA room with an additional alternative embodiment in which the pressure control system includes an internal bladder disposed inside the CA room coupled to an external bladder disposed outside the CA room.

FIG. 15 is a diagrammatic representative view showing an alternative active air supply incorporating a supply of compressed gas.

FIG. 16 is a diagrammatic representation view of an alternative embodiment in which the bladder is disposed in a remote room.

FIG. 17A is a diagrammatic representation view of an alternative embodiment in which a bladder disposed in a remote room provides displacement for a plurality of CA rooms.

FIG. 17B is a diagrammatic representation view of a second alternative embodiment in which a bladder disposed in a remote room provides displacement for a plurality of CA rooms.

### DESCRIPTION OF THE CURRENT EMBODIMENT

Overview.

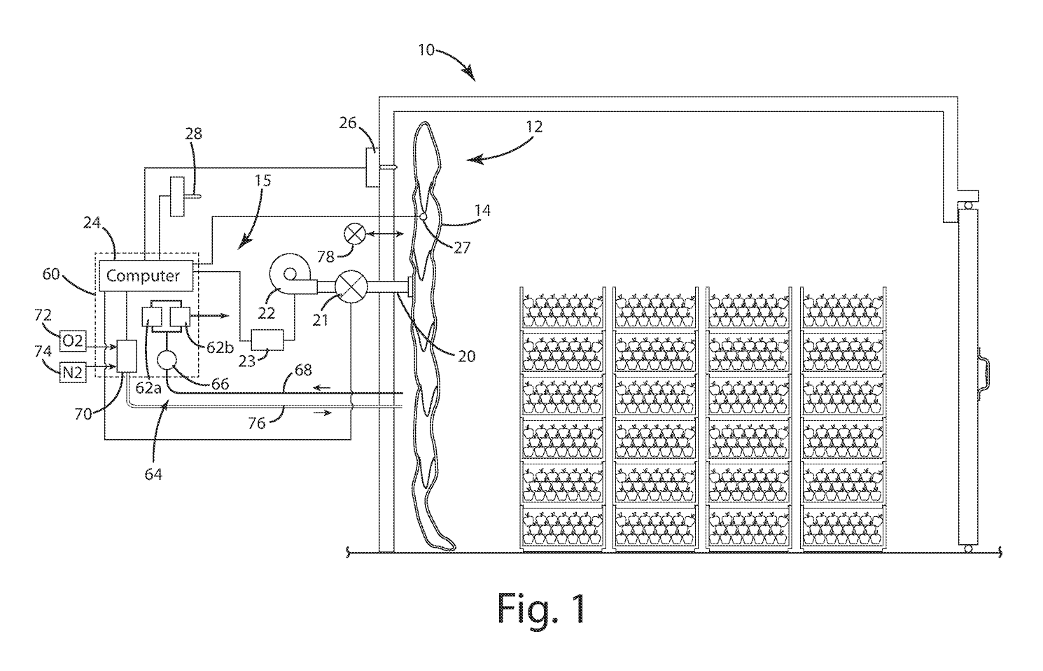

A controlled atmosphere room 10 (“CA room”) incorporating a pressure control system 12 in accordance with an embodiment of the present invention is shown in FIG. 1. The pressure control system 12 generally includes a bladder 14 and an active displacement control 15 that is operable to vary the displacement of the bladder 14 with respect to the CA room 10. In the illustrated embodiment, the bladder 14 is inflatable and the active displacement control 15 is implemented as an active air supply capable of selectively inflating and deflating the bladder 14. The bladder 14 is situated inside the CA room 10 or in another location wherein variations in the displacement of the bladder 14 will directly affect the internal pressure of the CA room 10. In the illustrated embodiment, the active air supply 16 includes a blower 22, a pipework 20 coupling the blower 22 to the bladder 14, a controller 24, an internal pressure sensor 26 and an external pressure sensor 28. In use, the controller 24 monitors the internal pressure of the CA room 10 using internal pressure sensor 26, barometric pressure using external pressure sensor 28 and operates the blower 22 to control the size (and consequently the displacement) of the bladder 14 based on the relative difference between internal pressure and barometric pressure. As an alternative to using separate internal and external pressure sensors, the active air supply 16 may use a single differential pressure sensor to determine the difference in pressure between the interior of the CA room 10 and barometric (or ambient) pressure. For example, the controller 24 may operate the blower 22 to inflate the bladder 14 to increase the internal pressure of the CA room 10 when barometric pressure increases or deflate the bladder 14 by operating the blower 22 in reverse to decrease the internal pressure of the CA room 10 when barometric pressure decreases. Alternatively two blowers may be used. One to increase bladder volume and the other to decrease bladder volume. In this illustrated embodiment, the controller 24 may be configured to maintain the internal pressure of the CA room 10 substantially equal to or somewhat above the barometric pressure. To facilitate use of the invention in CA rooms of different sizes, the present invention may be implemented using one or more modular bladders that can be joined to the active air supply 16 in essentially any number to provide the desired inflation/deflation capacity.

As noted above, the present invention relates to a pressure control system 12 for use with a CA room 10 for perishable commodities, such as fruits and vegetables. The present invention is well-suited for use in essentially any gastight (or substantially gastight) space, and the term “CA room” is intended to broadly encompass any gastight (or substantially gastight) space used in the storage of perishable commodities, such as fruits and vegetables. In the various illustrated embodiments, the CA room 10 is shown as a generally rectangular enclosed structure of a particular size and shape, the CA room 10 may have essentially any size or shape appropriate for the commodities to be stored. The design and manufacture of CA rooms are well-known and therefore will not be described in detail.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

Pressure Control System.

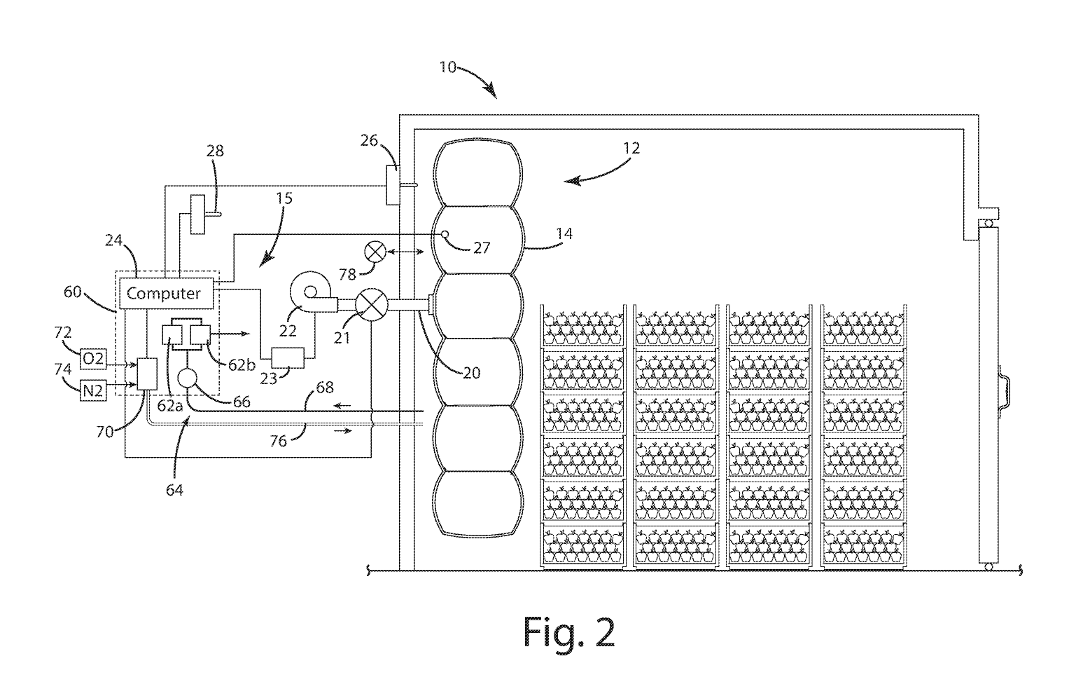

As noted above, the pressure control system 12 of FIGS. 1-2 generally includes a bladder 14 and an active displacement control 15. As discussed in more detail below, the active displacement control 15 is configured to control the internal pressure of the CA room 10 by adjusting the volume of CA room atmosphere that is displaced by the bladder 14. In use, the active displacement control 15 of the illustrated embodiment monitors the barometric pressure and the pressure inside the CA room and adjusts the displacement of the bladder 14 based on these pressures. In the embodiment of FIGS. 1-2, the bladder 14 is inflatable and its displacement is varied by adjusting its level of inflation. For purposes of comparison, FIG. 2 shows the bladder 14 in a fully inflated state and FIG. 1 shows the bladder 14 in a partially deflated state. As is evident from the illustrations, the amount of CA room atmosphere displaced by the bladder 14 varies between FIG. 1 and FIG. 2. As shown in FIGS. 1-2, the bladder 14 is situated inside the CA room 10, but it may be disposed in another location where its inflation/deflation will directly affect in the internal volume and consequently the internal pressure of the CA room 10. Alternative embodiments with the bladder located outside the CA room 10 are discussed below.

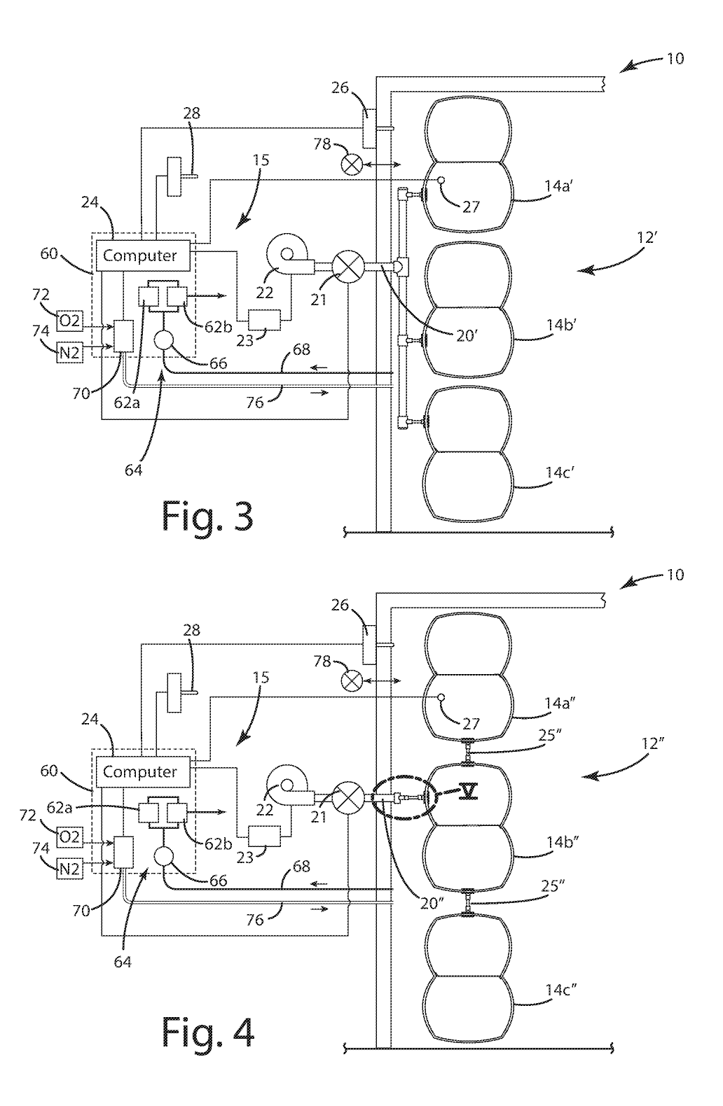

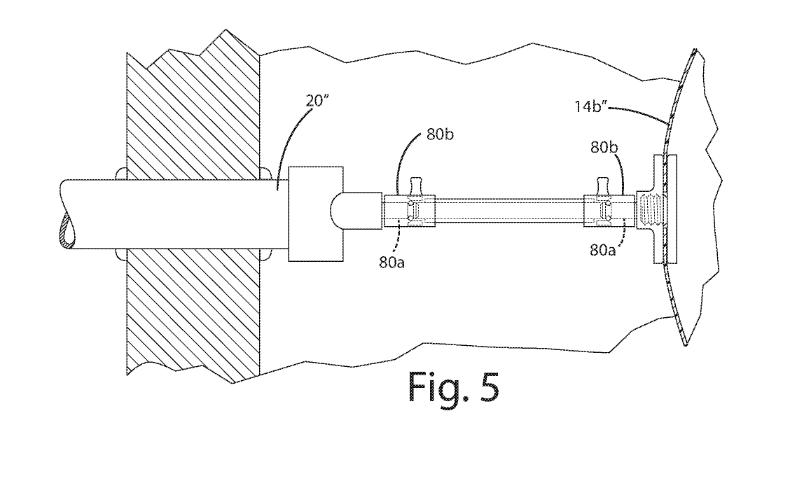

In the illustrated embodiment, the bladder 14 is a flexible walled structure that is hermetically sealed and defines an internal space that is isolated from the CA room atmosphere. The bladder can be inflated and deflated with ambient air or other fluids, as desired. For example, the bladder 14 may be manufactured from a flexible, but largely inelastic material, capable of being inflated and deflated, such as Polyvinyl Chloride (PVC). In the embodiment of FIGS. 1 and 2, the bladder 14 is generally bag-shaped having an opening that is sealed to the end of pipework 20 so that the blower 22 is capable of moving air into and out of the bladder 14. The size, shape and number of bladders may vary from application to application. For example, the size of the bladder 14 may be selected on a CA room-to-CA room basis to allow compensation for a wide range of typical barometric pressure changes in that specific CA room. In typical applications, it is desirable, but not necessary, for the bladder 14 to have a volume capacity that is roughly equivalent to approximately 3% of the volume of the CA room 10. To illustrate, in a CA room with an internal volume of 37,500 ft³, the bladder 14 may have a capacity in the range of about 1,000 ft³ to 1,300 ft³. These specifications are merely exemplary and the size of the CA room(s) and the bladder(s) may vary from application to application, as desired. As an alternative to providing each CA room with a single bladder that is sized for that CA room, the pressure control system 12 may incorporate modular bladders 14 that can be joined to one another as needed to expand the capacity of the system to correspond with the size of the CA room. For example, the system 12 may include bladders 14 with an internal volume of approximately 25 cubic feet, and the number of modular bladders 14 installed in a specific CA room may be selected to provide the desired overall volume. An embodiment incorporating modular bladders is shown in FIG. 3. In this embodiment, three modular bladders 14a-c′ are installed in the CA room 10. In this embodiment, the pipework 20′ enters the CA room and splits into three segments that supply air in parallel to all three modular bladders 14a-c′. A second embodiment incorporating modular bladders is shown in FIG. 4. In this embodiment, the pressure control system 12″ includes three modular bladders 14a-c″ and the pipework 20″ is directly coupled to modular bladder 14b″. Modular bladder 14b″ is, in turn, coupled to modular bladder 14a″ and 14c″ via flow lines 25″. The modular configurations shown in FIGS. 3 and 4 are exemplary, and it should be understood that the size, shape and number of modular bladders, as well as the configuration of the pipework, may vary from application to application.

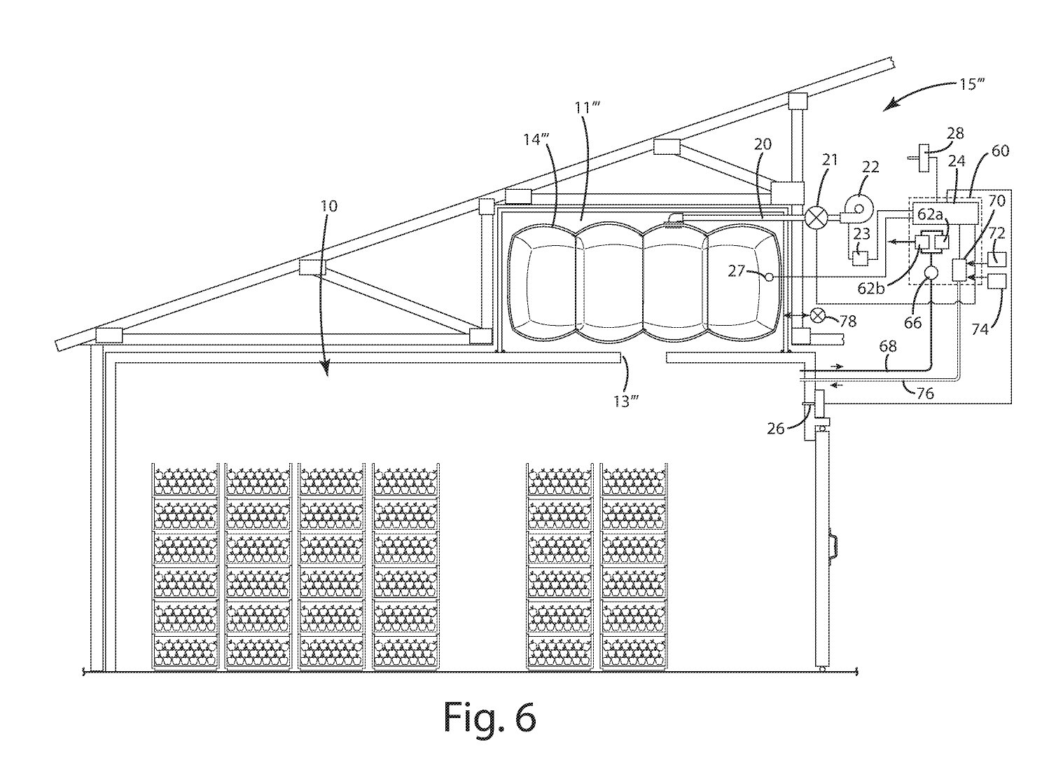

To facilitate installation, the bladder(s) 14, 14a-c′ and 14a-c″ may be joined to the pipework 20, 20′ and 20″ or to one another using quick-connect fittings. For example, FIG. 5 is an exploded view showing male and female quick-connect fittings 80a-b that can be used to join bladder 14b″ to the pipework or to adjoined pipe segments. FIG. 5 shows a snap-type ball latching quick-connect fitting, however, essentially any type of quick-connect fitting may be incorporated into the present invention, such as double shut off-type quick-connect fittings. In applications where quick-connect fittings are not warranted, any suitable alternative connection may be employed, including essentially any alternative temporary or permanent connections.

The bladder 14 may have essentially any desired shape. However, in the embodiment of FIG. 1-2, the bladder 14 is shaped to minimize the amount of floor space consumed by the bladder 14. This may help to maximum the amount of storage space available for stored commodities. For example, the bladder 14 may be configured to be tall and wide, but to have a relatively shallow depth so that it extends along a wall of the CA room while minimizing how far it extends into the CA room. Similarly, the modular bladders 14a-c′ and 14a-c″ may be configured to extend along the wall and minimize how far they extend into the CA room.

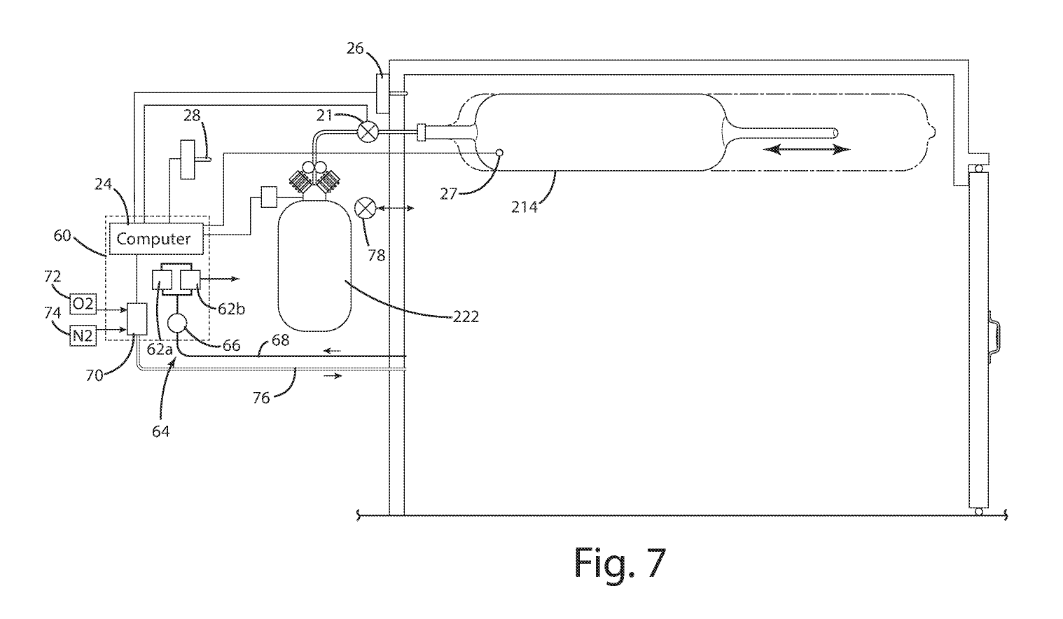

As shown in FIGS. 1-4, the bladders 14, 14a-c′ and 14a-c″ may be positioned adjacent a wall of the CA room 10, where they occupy the void space between the stored commodities and the walls to limit interference with storage. However, the bladder(s) may be positioned essentially anywhere in the CA room 10. As an alternative to positioning the bladder(s) directly in the CA room 10, the bladder may be positioned in a space that is separate from but in fluid communication with the main CA room. This may reduce the impact of the bladder on commodity storage space. For example, the bladder 14′″0 may be positioned in an attic 11′″ or cupola as shown in FIG. 6. As shown, the CA room 10′″ may include an opening 13′″ in the ceiling that provides fluid communication between the attic 11′″ (or cupola) and the main CA room 10′″. As a result, inflation and deflation of the bladder 14′″ in the attic (or cupola) affects the internal pressure of the CA room 10′″.

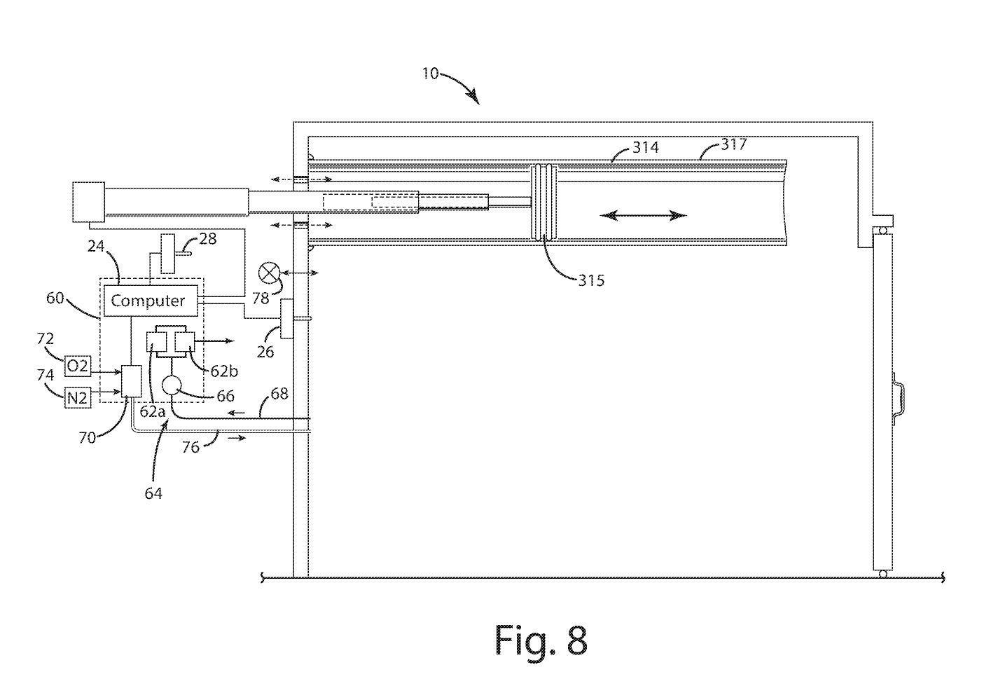

Although the bladders of FIGS. 1-5 are generally non-elastic, the bladder may be manufactured from an elastic material that expands and contracts (e.g. in a balloon-like manner) in response to the movement of air into and out of the bladder. For example, FIG. 7 illustrates an elastic, balloon-like bladder 214. As shown, the bladder 214 of FIG. 7 is configured to elastically expand and contract primarily in a longitudinal direction as it is inflated and deflated. The bladder 214 may, however, be configured to elastically expand and contract in essentially any other way. In elastic bladder applications, the bladder 14 may be manufactured from butyl or other durable flexible products.

In the illustrated embodiments, the bladders 14, 14a-c′, 14a-c″, 14′″ and 214 are supported only by the pipework. More specifically, the bladders are shown affixed only to the end of the pipework without additional support. In other embodiments, the bladders may be provided with additional support. For example, the bladders may be suspended from the wall or the ceiling by one or more hooks, straps, nets or essentially any other suitable mechanism.

Active Displacement Control.

As noted above, the pressure control system 12 is configured to adjust the internal pressure of the CA room 10 and, in the illustrated embodiments, is configured to maintain substantial correlation between the internal pressure of the CA room 10 and barometric pressure. The specific type of correlation may vary from application to application, as desired. To illustrate, in some applications, the pressure control system 12 may be configured to adjust internal pressure so that it remains essentially equal to barometric pressure. In other applications, the pressure control system 12 may be configured to adjust internal pressure so that it generally remains somewhat above or somewhat below barometric pressure. For example, in some applications it may be desirable to maintain some level of positive pressure in the CA room 10 (relative to barometric pressure) so that any leaks in the CA room will tend to vent atmosphere from the CA room 10 rather than introduce external atmosphere into the CA room 10. This may help to prevent external gases, which are generally higher in oxygen content, from entering the CA room 10 and undesirably affecting the CA room gas mixture. In this example, it may be desirable to operate the pressure control system 12 to maintain the CA room internal pressure at approximately 0.05 inches of water column above barometric pressure, but the differential may vary from application to application, for example, in the range of 0-0.01 to 0.15 inches of water column.

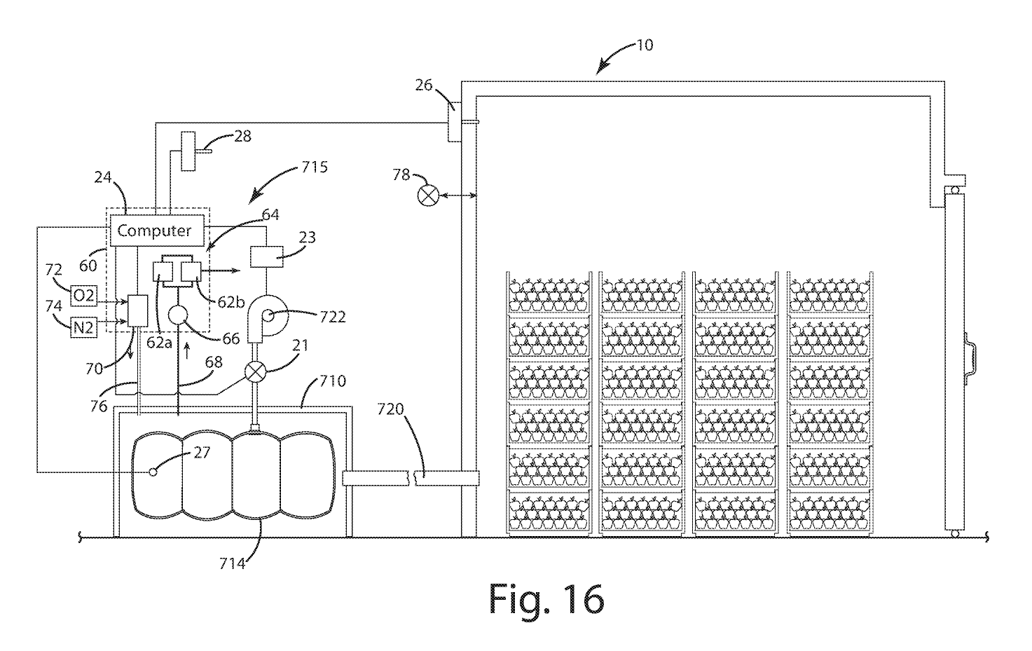

The pressure control system 12 includes an active displacement control 15 that varies the displacement of the bladder 14, thereby adjusting the internal pressure of the CA room. The configuration of the active displacement control 15 will vary from application to application depending in large part on the design and configuration of the bladder. In the embodiment of FIGS. 1-4, the bladder is inflatable and the active displacement control 15 includes an active air supply 16 that operates by inflating and deflating the bladder. In the illustrated embodiments, the active air supply 16 generally includes a blower 22, a controller 24, an internal pressure sensor 26 and an external pressure sensor 28. As an alternative to using separate internal and external pressure sensors, the active air supply 16 may use a single differential pressure sensor to determine the difference in pressure between the interior of the CA room 10 and barometric (or ambient) pressure. In this alternative, the differential pressure sensor may be disposed in the wall of the CA room 10 (e.g. pressure sensor 26) and may include a first input in communication with the interior of the CA room 10 and a second input in communication with the ambient environment outside the CA room 10. For example, internal pressure sensor 26 shown in the various drawings could be replaced by a conventional differential pressure sensor. In use, the differential pressure sensor may provide an output to the controller 24 that is indicative of the difference in pressure between the CA room 10 and the outside environment (e.g. barometric). The blower 22 may be essentially any blower capable of providing the desired volume of air flow. In the illustrated embodiment, the blower 22 is a regenerative blower available from Fuji Electric. The blower 22 is driven by a variable speed drive 23 (e.g. a variable speed, reversible electric motor) and has a maximum flow rate of cfm=0.1*bladder volume. As a result, air can be moved at a variable rate into and out of the bladder 14 by the blower 22. In the illustrated embodiment, a valve 21 is positioned in the pipework 20 between the blower 22 and the bladder 14. The valve 21 may be closed to isolate the bladder 14 from the blower 22, for example, to prevent the backflow of air from the bladder 14 to the blower 22. In some applications, the valve 21 may be eliminated. For example, in applications where the blower 22 is configured so that it will not vent backflow, the valve 21 may be eliminated. In alternative embodiments, the blower 22 may be replaced by other sources of pressurized air. For example, in FIG. 7, the bladder 214 is manufactured from an elastic material and the blower 22 is replaced by an air compressor 222. The air compressor 222 may be selected to provide the desired pressure and flow rate. As another example, in FIG. 15, the blower 22 is replaced by a canister of compressed air 222′. In this embodiment, the canister of compressed air 222′ may be joined to the bladder 14 by a pipework 20 that includes a three-way valve 221′ that is operated by the controller 224′. The controller 224′ may operate the valve to connect the canister 222′ to the bladder 14 to inflate the bladder 14, to vent the bladder 14 to the environment to deflate the bladder 14 or to close off the canister 222′ and the bladder 14 when there is no need to vary the displacement of the bladder 14.

Referring now to FIG. 1, the internal pressure sensor 26 may be situated in essentially any desired location within the CA room 10 (or other location having the same internal pressure as the CA room). It may be desirable to mount the internal pressure sensor 26 to the wall near the top of a wall where it is unlikely to interfere with storage of commodities. The external pressure sensor 28 may be disposed in essentially any location outside the CA room 10 where it is subject to barometric pressure. The pressure control system 12 may include any of a wide range of commercially-available pressure sensors. In the illustrated, the external pressure sensor 28 is a PCB mount barometric pressure sensor available from International Controlled Atmosphere. In alternative embodiments that utilize a differential pressure sensor instead of separate internal and external pressure sensors, the differential pressure sensor may be a 616KD pressure sensor available from Dwyer Instruments or any other suitable differential pressure sensor.

In one embodiment, the controller 24 monitors the internal pressure of the CA room 10 using internal pressure sensor 26, monitors the barometric pressure using external pressure sensor 28 and operates the blower 22 to control the size of the bladder 14 based on the relative difference between the sensed internal pressure and the sensed barometric pressure. As discussed above, the controller 24 may be configured to maintain essentially any desired correlation between internal CA room pressure and barometric pressure. For example, when it is desirable for the internal pressure to be substantially equal to the barometric pressure, the controller 24 may inflate the bladder 14 to increase the internal pressure of the CA room 10 when the internal pressure is lower than barometric pressure (e.g. barometric pressure rises or gases haves leaked from the CA room) or it may deflate the bladder to decrease the internal pressure when the internal pressure is greater than barometric pressure (e.g. barometric pressure falls or additional gases have been introduced into the CA room). As discussed above, the controller 24 may determine the difference between internal CA room pressure and barometric pressure using a single differential pressure sensor rather than separate internal and external pressure sensors. In alternative embodiments of this type, the controller 24 does not need to compare separate internal and external pressure measurements, but instead monitors the difference between the internal pressure of the CA room 10 and the barometric pressure based on the output of the differential pressure sensor.

The pressure control system 12 may also include a bladder pressure sensor 27 situated in the bladder 14. The bladder pressure sensor 27 may be coupled to the controller 24 so that the controller 24 can determine the internal pressure of the bladder. The bladder pressure sensor 27 may be essentially any type of pressure sensor. To illustrate, the sensor may provide an output that is representative of the pressure within the bladder or it may provide an output that is representative of the differential pressure between the bladder and the CA room or between the bladder and the environment (e.g. barometric pressure). In operation, the bladder pressure sensor 27 may allow the controller 24 to provide a variety of functions. For example, output from the bladder pressure sensor 27 can be used by the controller 24 to determine if the blower 22 (or other supply of pressurized air) is working. As another example, the bladder pressure sensor 27 may be used to ensure that internal pressure within the bladder 14 does not exceed certain threshold values, for example, does not exceed a predetermined maximum pressure. This may help to prevent the bladder 14 from over-inflation. Additionally, the bladder pressure sensor 27 may be used by the controller 24 to determine when to initiate the bladder recovery cycle (discussed below). For example, if the internal pressure of the bladder 14 exceeds a maximum threshold, the bladder recovery cycle may be initiated to deflate the bladder 14 to the desired state. Similarly, if the internal pressure of the bladder 14 falls below a minimum threshold, the bladder recovery cycle may be initiated to inflate the bladder 14 to the desired state. In applications that include multiple interconnected bladders, the system may include a single pressure sensor in one of the bladders or separate pressure sensors may be incorporated into each bladder.

Although the embodiment of FIGS. 1-7 incorporate inflatable bladders that can be operated by a blower 22 or other active air supply, the controller 24 may be configured to operate the bladders using essentially any appropriate mechanical, electronic, hydraulic or pneumatic system capable of varying the displacement of the bladder. A variety of alternative active displacement control systems are described below in the context of a number of alternative bladders.

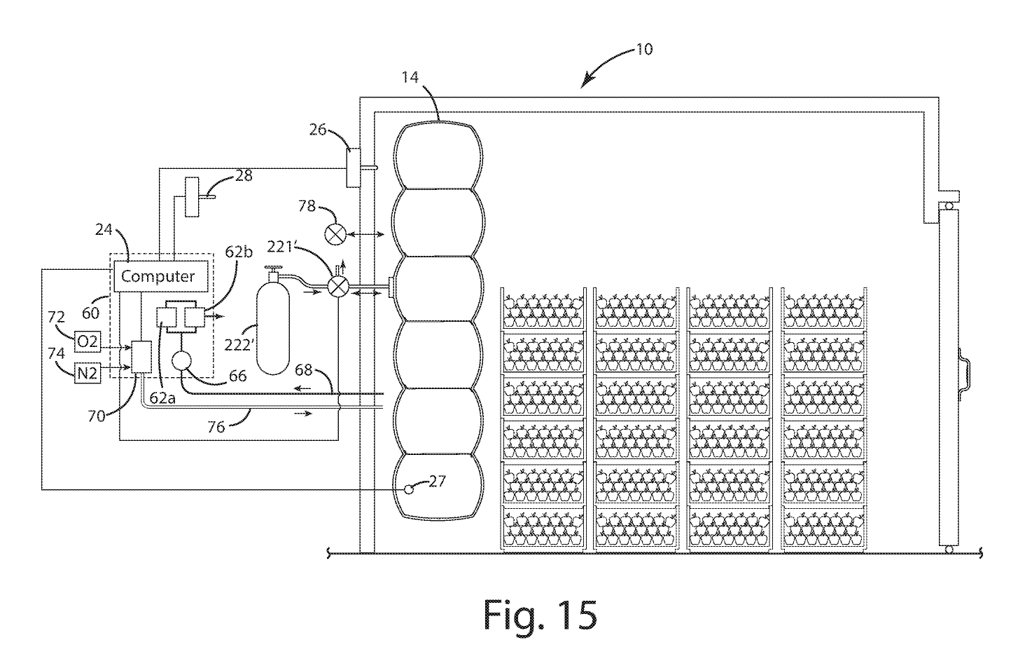

FIG. 14 shows an alternative embodiment in which the active displacement system includes an external bladder 915. In this embodiment, the external bladder 915 is coupled to the internal bladder 914 by pipework 920. The pipework 920 allows air to move freely between the internal bladder 914 and the external bladder 915. In use, the external bladder 915 is subject to barometric pressure so that it actively adjusts the displacement of the internal bladder 914 based on pressure differentials between the internal pressure in the CA room 10 and the barometric pressure. For example, as barometric pressure increases, air from the external bladder 915 will move into the internal bladder 914 increasing the displacement of the internal bladder 914 and consequently increasing the pressure inside the CA room 10. Similarly, if barometric pressure decreases, air from the internal bladder 914 will move into the external bladder 915, thereby decreasing the displacement of the internal bladder 914 and the pressure in the CA room 10. Although shown with both the internal bladder 914 and external bladder 915 inflated, the amount of air contained in the combined bladders may vary from application to application. For example, it may be desirable for the bladders 914, 915 to be partially deflated.

The present invention may be integrated into essentially any CA room. Many conventional CA rooms include a control system that controls operation of the CA room. For example, the CA room control system may include sensors, gas analyzers and other components that allow the control system to monitor and adjust gas composition, temperature and humidity in the CA room. In the embodiment of FIG. 1, the control system 60 of the CA room 10 includes oxygen and carbon dioxide analyzers 62a-b capable of determining the oxygen and carbon dioxide levels in a gas. In the illustrated embodiment, the analyzers 62a-b are housed within the housing of the control system 60, but that is not necessary. Although a variety of analyzers may be suitable for use in the present invention, the control system 60 may include the GCS 250 portable analyzer or the GCS integrated analyzer, both available from Gas Control Systems, Inc. These analyzers 62a-b may be used to test the CA room atmosphere. To that end, the control system 60 of the illustrated embodiment includes a sampling control system 64 that allows the system 60 to selectively supply the analyzers 62a-b with atmosphere from the interior of the CA room 12. In operation, the sampling control system 64 takes a sample of the atmosphere and wastes it to air once the testing is complete. This is not necessary, however, and it may be desirable in some applications to return CA room samples to the CA room atmosphere.

The sampling control system 64 may include a pump 66 for moving atmosphere into the analyzers 62a-b. To provide a path for routing atmosphere between the CA room 10 and the sampling control system 64, a sample line 68 is coupled between the CA room 10 and the sampling control system 64. A return sample line (not shown) can be added when it is desirable to return sampled air to the CA room 10. The sample line 68 may be poly tubing, copper tubing or essentially any other structure suitable for providing an atmosphere or gas flow path. For example, the control system 60 may actuate the pump 66 to route gas from the CA room 10 to the analyzers 62a-b. Although the illustrated embodiment includes oxygen and carbon dioxide analyzers that are shared between the CA room and the enclosure, separate analyzers may be provided for each environment. Also, the oxygen and carbon dioxide sensors may be replaced or supplemented with other types of sensors based on the methodology used for providing DCA, such as ethanol accumulation or chlorophyll fluorescence.

The control system 60 may also have the ability to supply one or more gases to the CA room 10. More specifically, the control system 60 may have the ability to add O2 and/or Nitrogen (N2) to the CA room atmosphere. For example, if respiration causes the oxygen content in the CA room 10 to become too low, the control system 60 may supply oxygen to the CA room 10. This may be achieved, for example, by pumping ambient air into the CA room 12. As another example, if it is desirable to reduce the amount of oxygen in the CA room 10, the controller 60 may introduce N2 into the CA room 10.

In the illustrated embodiment, the control system 60 is operatively coupled to a gas manifold 70 for selectively distributing gases to the CA room 10. The illustrated embodiment includes a gas manifold 70 that is a generally conventional manifold with a plurality of ports and a plurality of two-way solenoids that allow O2 or N2 to be supplied to the CA room 10. For example, an O2 supply 72 and an N2 supply 74 may be connected to two different ports on the gas manifold 70. In addition, a CA room supply line 76 may be connected to a third port. The control system 60 may actuate the solenoids to connect either the oxygen supply 72 or the nitrogen supply 74 to the CA room supply line 76, thereby allowing either nitrogen or oxygen to be supplied to the CA room 10. The CA room 10 may include a pressure exhaust 78 that allows atmosphere to vent to outside the environment if the pressure in the CA room 10 exceeds a threshold or that allows air to be drawn into CA room 10 from the outside environment if the pressure falls too low.

In the illustrated embodiment, the controller 24 of the pressure control system 12 is configured to integrate with the control system 60 of the CA room 10. The control functions of the CA room 10 and the pressure control system 12 may be implemented using a single controller or a plurality of controllers. For example, control of the CA room 10 and the pressure control system 12 may be distributed across a plurality of controllers. The controllers may operate independently of one another or they may be coupled by a communication bus or network that allows coordinated operation. As an alternative, a single controller may be provided that operates the CA room functions and pressure control system 12 (as shown). The single controller may be programmed to control operation of the CA room, as well as to monitor and adjust for the pressure differential between the CA room and the barometric pressure. The controller 24 may be a GCS integrated controller available from Gas Control Systems, Inc., but essentially any micro controller or plurality of controllers capable of individually or collectively providing the functionality described herein may alternatively be used.

Select Alternative Bladders.

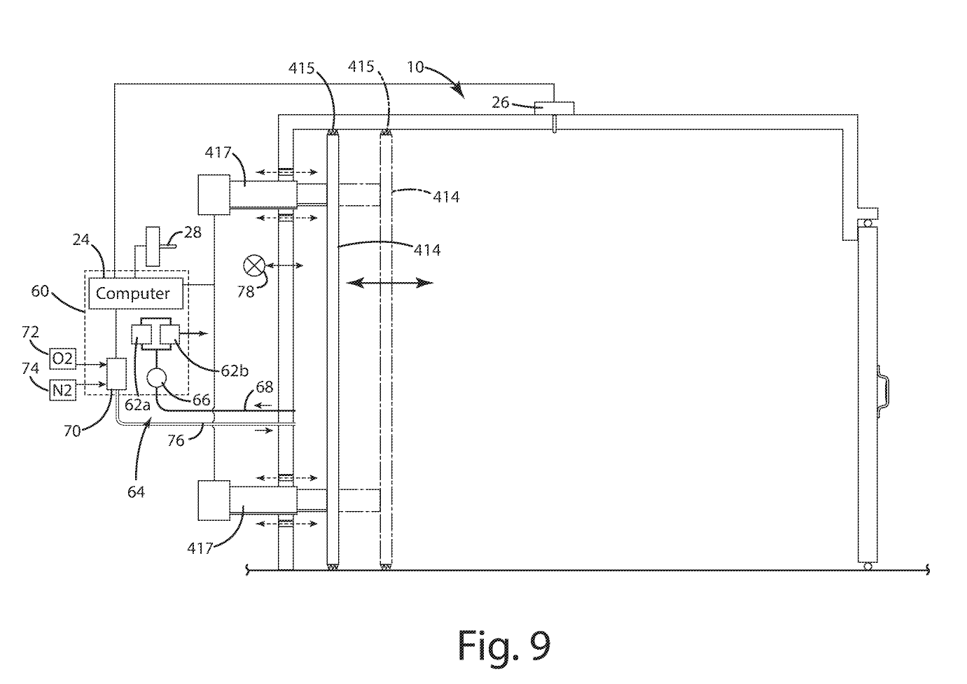

Although the bladders 14 shown in FIGS. 1-7 are inflatable bladders, the present invention is not limited to inflatable bladders. Rather, the term “bladder” is used broadly herein to refer to essentially any structure or mechanism capable of actively varying the internal volume of a CA room through displacement. For example, an alternative to an inflatable bladder is shown in FIG. 8. In this embodiment, the inflatable bladder 14 is replaced by a piston/cylinder arrangement 314. The piston 315 may be moved within the cylinder 317 to vary the displacement of the piston/cylinder arrangement 314 and consequently the internal volume of the CA room. The piston/cylinder arrangement 314 may be actuated by essentially any electrical, mechanical, hydraulic or pneumatic drive system capable of providing linear movement of the piston 315 within the cylinder 317. For example, the active displacement system 15 may include a motor and screw drive (not shown) that move the piston 315 linearly within the cylinder 317. As another example, the active displacement system 15 may include a generally conventional hydraulic or pneumatic drive system (not shown) that extends the piston through the introduction of pressurized fluid into the rod side of the cylinder and retracts the piston through the withdrawal of fluid and/or the use of a return spring.

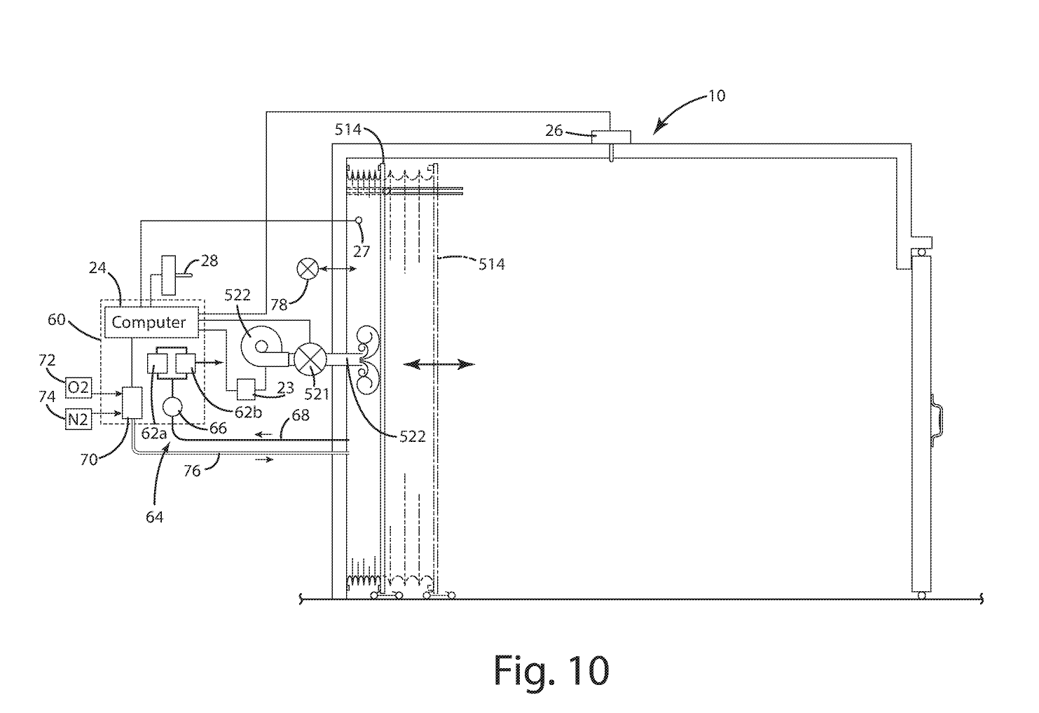

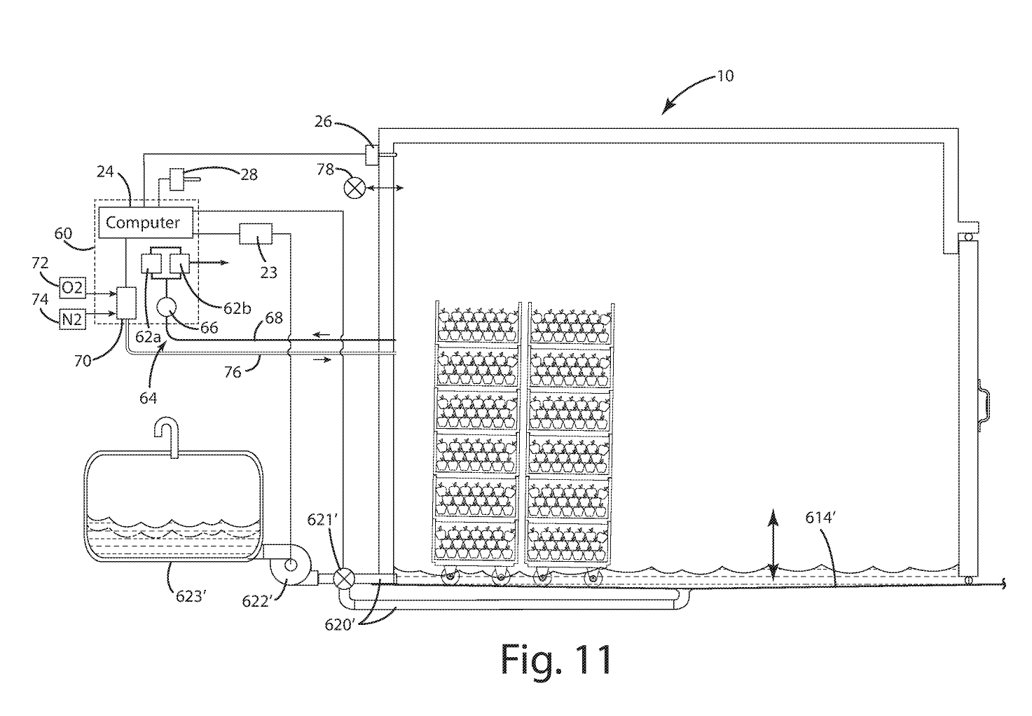

As another example of an alternative bladder shown in FIG. 9, the inflatable bladder 14 may be replaced by a movable wall 414 that can be operated to vary CA room volume. The movable wall 414 may be sealed around its perimeter, for example, by seals 415, so that movement of the wall within the CA room changes its displacement, thereby changing room volume. FIG. 9 shows the wall 414 is an extended position in phantom lines. Similarly, as shown in FIG. 10, the bladder may be a bellow arrangement 514. The bellow arrangement 514 defines an internal space 515 that is sealed from the interior of the CA room, so that expansion and contraction of the bellow arrangement 514 results in changes to effective room volume. FIG. 10 shows the bellow arrangement 514 in an extended position in phantom lines. The movable wall 414 and the bellow arrangement 514 may be moved by essentially any electrical, mechanical, hydraulic or pneumatic drive system. For example, as shown in FIG. 9, the active displacement control for the movable wall 414 may include a pair of hydraulic or pneumatic cylinder 417 that can be extended and retracted to move the wall 414. As another example shown in FIG. 10, the active displacement control for the bellow arrangement 514 may include an active blower 522 or other source of compressed air that moves the bellow arrangement 514. The bellow arrangement 514 may be inflated by introducing air into the bellow arrangement 514 by opening valve 521 and blow air along pipework 520 and may be deflated by opening valve 521 and reversing the blower 522. As another example, a mechanical system, such as a motor and linkage (not shown), may be used to move the wall 414 or articulate the bellow arrangement 515.

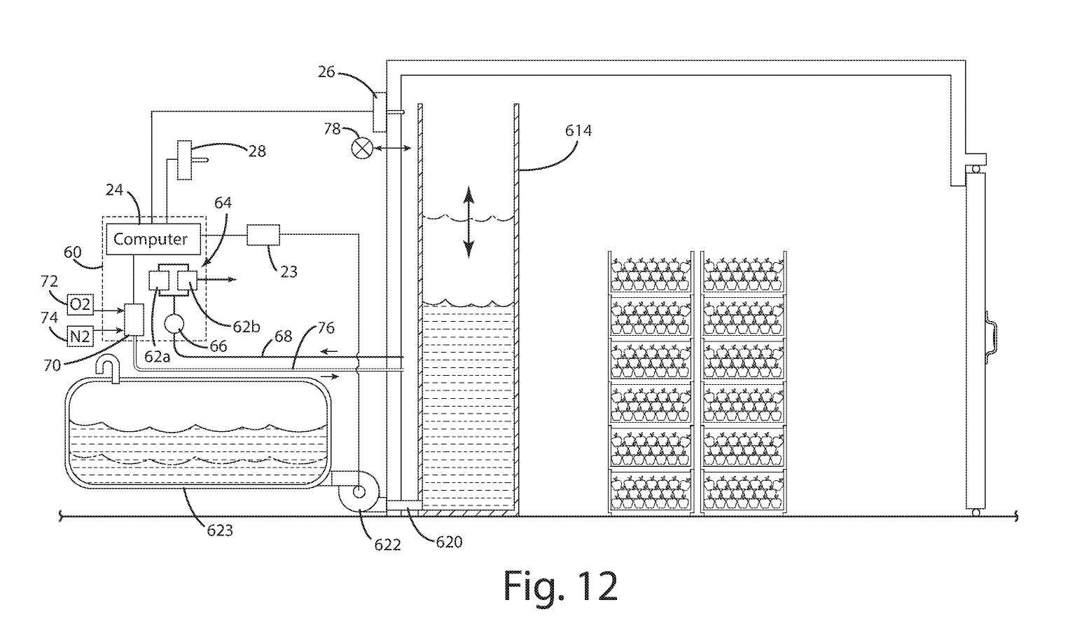

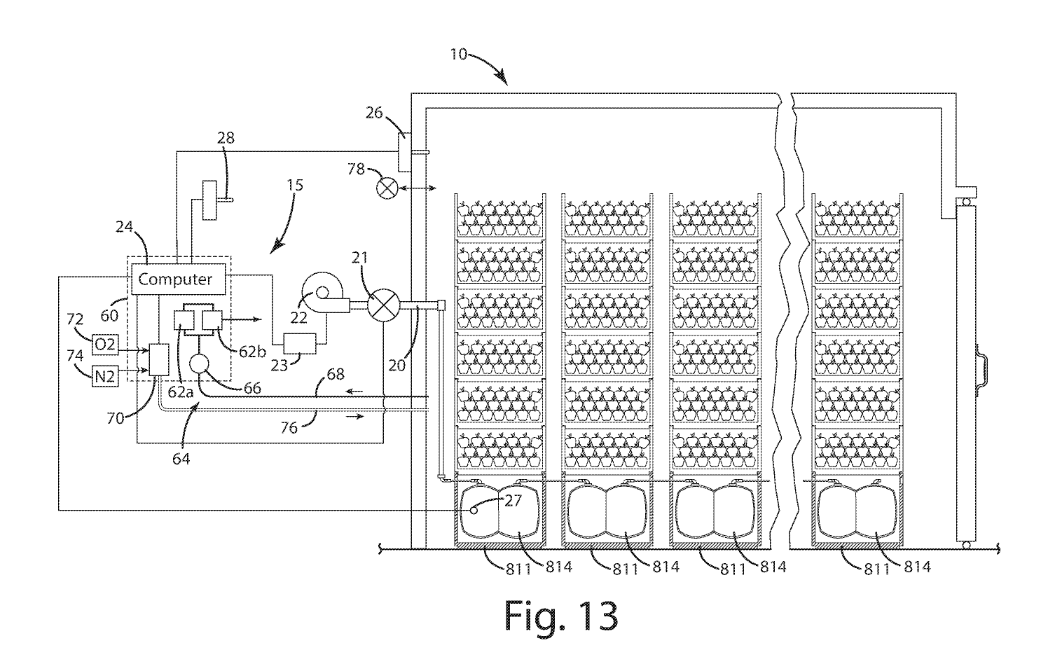

Yet another alternative embodiment is shown in FIG. 12. In this alternative embodiment, the inflatable bladder is replaced by a liquid displacement system. As shown, the CA room may include a receptacle 614 capable of retaining water or other liquids. In this embodiment, water can be supplied to and removed from the receptacle 614 to vary displacement and control the internal volume of the CA room. The active displacement control 15 may include a liquid pump 622 that is operable to move water into and out of the liquid displacement system as appropriate via pipework 620. The system may include a corresponding water reservoir 623 situated outside the CA room 10. FIG. 11 shows an alternative liquid displacement system in which the CA room 10 is itself the liquid receptacle. In this embodiment, a leak-proof basin 614′ may be provided over the floor of the CA room. The basin 614′ may be coextensive with the floor of the CA room or it may extend over only a portion of the floor. If the CA room 10 is sufficiently leaktight without the basin, the basin may be eliminated and the liquid may simply be pumped directly into the CA room 10. If desired, the commodities may be stored in bins or atop pallets that keep the commodities above the liquid level in the CA room 10. Again, the active displacement control 15 may include a liquid pump 622′ for varying the displacement of the liquid displacement system using liquid, such as water, stored in water reservoir 623′. The pipework 620′ may extend into the CA room 10 at the base of a wall and/or it may be integrated into a drain in the floor. For purposes of disclosure, FIG. 11 shows both pipework options. If both options are included, the system may include a three way valve 621′. The valve 621′ may be movable between a first position that allows the pump 622′ to supply water to the CA room via the pipework extending through the wall, a second position that allows the pump 622′ to withdraw water from the CA room via the drain and pipework in the floor and a third position that closes the pipework to maintain the current water level.

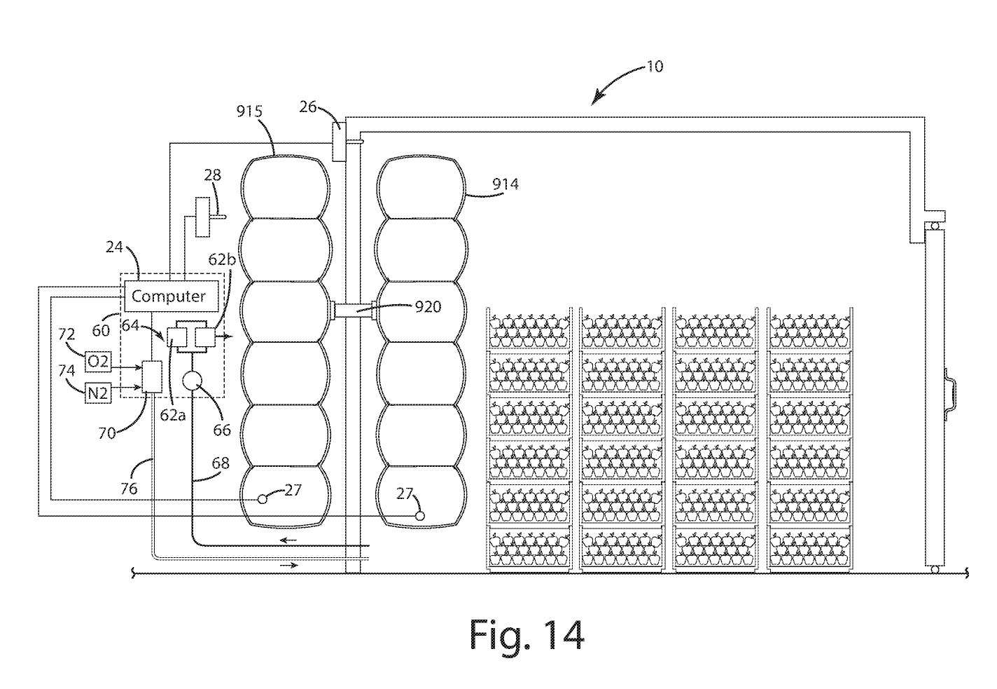

FIG. 13 shows an alternative embodiment in which a plurality of modular bladders 814 as situated in storage bins 811. In the illustrated embodiment, the storage bins 811 are generally conventional storage bins with rigid walls that create “reserved” space for the bladders 814. Commodities may be stacked on top of the storage bins 811 (as shown). Alternatively, the storage bins 811 may be stacked on top of each other (not shown). In the illustrated embodiment, the bladders 814 in adjacent storage bins 811 are operatively joined to one another in series so that air supplied to the first bladder 814 by blower 22 will flow in series to each of the additional bladders 814. The bladders 814 may be joined by pipe segments with quick-connect fittings, if desired. The bladder(s) 814 can be placed in any convenient storage bin 811 location throughout the room array.

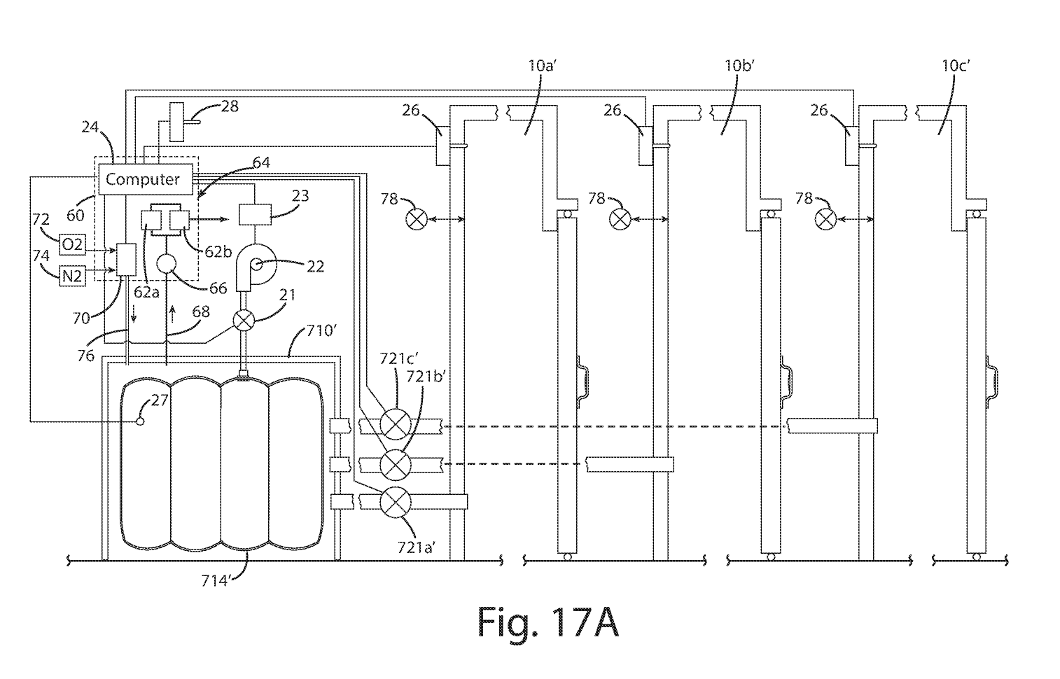

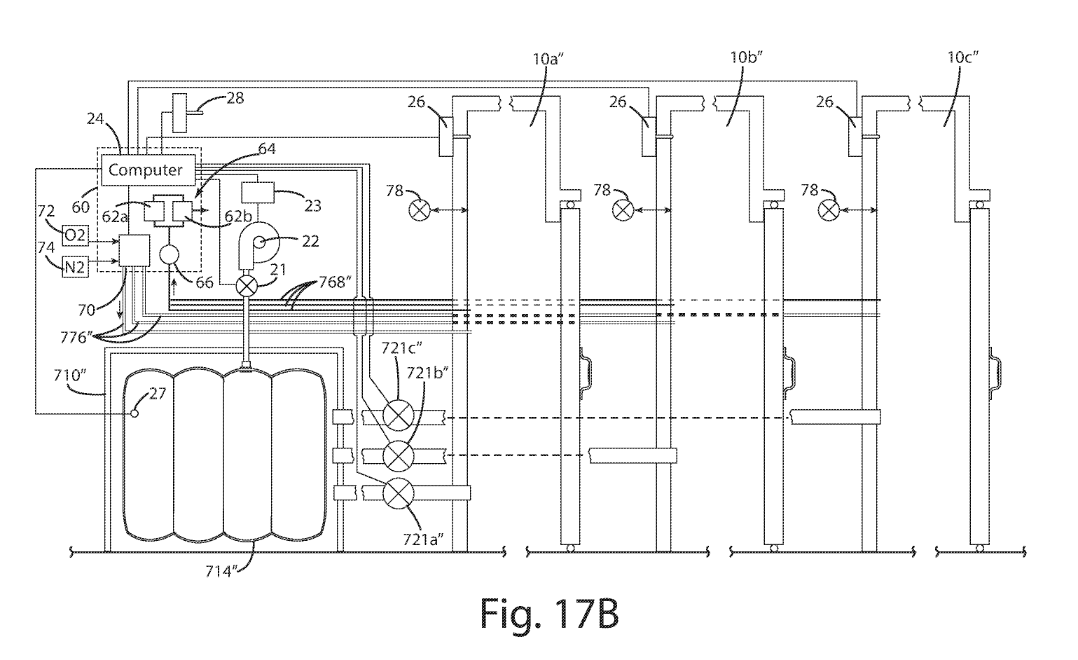

In alternative embodiments, the bladder 14 may be positioned in a confined space that is separate from, but in fluid communication with the CA room 10. An implementation of this option is shown in FIG. 16. In this embodiment, the CA room 10 is joined to a separate displacement room 710 by a pipework 720. The pipework 720 generally remains open, thereby providing fluid communication between the interior of the CA room 10 and the interior of the displacement room 710. If desired, the displacement room 710 may be positioned immediately adjacent to the CA room 10 to facilitate temperature control in the displacement room 710. For example, the displacement room 710 may share a common, uninsulated wall with the CA room 10 so that temperature control may be achieved, at least in part, by heat transfer through the shared wall. In use, the bladder 714 positioned in the displacement room 710 may be inflated and deflated by the active displacement control 715 to vary its displacement within the displacement room 710. The variations in bladder displacement in the displacement room 710 are communicated to the interior of the CA room 10 via the pipework 720, thereby affecting internal room pressure. Referring now to FIGS. 17A, a displacement room 710′ may be coupled to a plurality of CA rooms 10a-c′. In this embodiment, the pressure control system 12′ may include a network of pipes 720′ and a plurality of valves 721a-c′ that allow the displacement room 710′ to be coupled to one CA room 10a-c′ at a time to allow adjustment of that room. For example, to adjust pressure in CA room 10a′, the valve 721a′ for room 10a′ is opened and the valves 721b-c′ for CA rooms 10b-c′ are closed. After the valves are placed in the proper position, the displacement of the bladder 14 can be adjusted to set the proper CA room internal pressure. The controller 24′ may repeatedly cycle through each CA room 10a-c′ making the necessary adjustments to each. In the embodiment of FIG. 17A, a single control system 60′ is coupled to the displacement room 710′. In this embodiment, the control system 60′ monitors and affects the gas mixture in each CA room 10a-c′ while that room is coupled to the displacement room 710′. FIG. 17B is generally identical to the embodiment of FIG. 17A, except that a single control system 60″ is separately coupled to each CA room 10a-c″. More specifically, the control system 60″ includes separate sampling lines 68″ and supply lines 76″ that are coupled to each CA room 10a-c″ so that gas mixture can be monitored and adjusted separately from the displacement room 710″. The sampling lines 68″ may be coupled to the pump 766″ by a manifold (not shown) so that each CA room 10a-c″ can be sampled separately. Similarly, the supply lines 76″ may be coupled to the O2 supply 772″ and N2 supply 774″ by a manifold (not shown) so that each CA room 10a-c″ can be supplied additional gases separately.

Bladder Recovery Cycle.

In some applications, the controller 24 may be configured to return the bladder 14 to a specific state of inflation at various times. In some applications, it is possible that changes in bladder size over time will eventually place the bladder 14 at full inflation or complete deflation. When at full inflation, the bladder 14 cannot be expanded and is therefore unable to provide compensation for further increases in barometric pressure. Conversely, when the bladder 12 is at complete deflation, it can no longer be contracted and is therefore unable to provide compensation for further decreases in barometric pressure. To illustrate, in applications where the CA room 10 is slowly leaking gas into the outside environment, it may be necessary to continue to inflate the bladder 14 to continue to compensate for the leaked gases. As can be seen, this has the potential to eventually bring the bladder 14 to full inflation after which it is no longer possible for the bladder 14 to be used to increase internal pressure. To address the issue of over-inflation, the controller 24 may be configured to occasionally introduce new gases into the CA room 10 while simultaneously deflating the bladder 14. To address the issue of excessive-deflation, the controller 24 may be configured to occasionally vent gas from the CA room 10 while simultaneously inflating the bladder 14. The rate at which the bladder 14 is deflated or inflated may correspond substantially with the rate at which new gases are introduced into or vented from the CA room 10 so that changes in the differential between the internal pressure and barometric pressure are limited during this process. The bladder recovery cycle may be triggered by a pressure sensor (e.g. bladder pressure sensor 27) or another indicator that detects when the bladder has reached its maximum capacity and/or when the CA room pressure approaches an established maximum or minimum level. Activation thresholds of the recovery cycle may be established to be within the thresholds of the room pressure exhaust 78′ described above, thereby preventing atmosphere exchange between the CA room and the outside environment.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A pressure control system for a controlled atmosphere room, comprising:
a bladder configured to provide variable displacement, the bladder disposed such that variations in the displacement of the bladder vary an internal pressure of the controlled atmosphere room; and
an active displacement control operatively coupled to the bladder, the active displacement control including a pressure sensor, the active displacement control including a controller configured to vary the displacement of the bladder based at least in part on a sensed pressure provided by the pressure sensor.

2. The pressure control system of claim 1 wherein the bladder is an inflatable bladder.

3. The pressure control system of claim 2 wherein the active displacement system includes an air supply coupled to the bladder by a pipework.

4. The pressure control system of claim 3 wherein the air supply includes a blower.

5. The pressure control system of claim 4 wherein the blower is a reversible, variable speed blower capable of supplying air to and withdrawing air from the bladder at different rates.

6. The pressure control system of claim 1 wherein the bladder is further defined as a plurality of modular bladders operatively coupled to the active displacement control, the active displacement control configured to vary the combined displacement of the plurality of modular bladders to control the internal pressure.

7. The pressure control system of claim 6 wherein each modular bladder is disposed in a rigid storage bin.

8. The pressure control system of claim 1 wherein the controlled atmosphere room includes an attic and the bladder is disposed in the attic.

9. The pressure control system of claim 1 further including a displacement room separate from the controlled atmosphere room, the bladder disposed in the displacement room, the displacement room in fluid communication with the controlled atmosphere room whereby variations in the displacement of the bladder result in the displacement room affect internal pressure.

10. The pressure control system of claim 1 wherein the bladder is at least one of a piston/cylinder arrangement, a bellows arrangement, an active wall or a fluid reservoir.

11. The pressure control system of claim 10 wherein the active displacement control varies the displacement of the bladder mechanically, electrically, pneumatically or hydraulically.

12. The pressure control system of claim 1 wherein the controller is configured to vary the displacement of the bladder based at least in part on a difference between an internal pressure of the controlled atmosphere room and an external pressure outside the controlled atmosphere room.

13. The pressure control system of claim 12 wherein the controller is configured to maintain positive pressure in the controlled atmosphere room.

14. The pressure control system of claim 1 further including a gas supply system for selectively supplying gas to the controlled atmosphere room; and
wherein the controller is configured to return the bladder to a predetermined displacement by reducing the displacement of the bladder while supplying gas to the controlled atmosphere room, the amount of gas supplied the controlled atmosphere room corresponding to the reduction in displacement of the bladder.

15. A storage system for commodities comprising:
a controlled atmosphere room;
a variable-displacement bladder operatively associated with the controlled atmosphere room such that variations in the displacement of the bladder vary the effective volume of the controlled atmosphere room and thereby vary an internal pressure of the controlled atmosphere room; and
a bladder displacement control operatively associated with the bladder, the bladder displacement control configured to selectively vary the displacement of the bladder.

16. The system of claim 15 further including at least one pressure sensor, the bladder displacement control configured to vary the displacement of the bladder based on an internal pressure within the controlled atmosphere room and an external pressure outside the controlled atmosphere room.

17. The system of claim 16 wherein the bladder is an inflatable bladder, the bladder displacement control varies the displacement of the bladder by selectively inflating and deflating the bladder.

18. The system of claim 17 wherein the bladder displacement control maintains positive internal pressure in the controlled atmosphere room.

19. The system of claim 18 wherein the bladder displacement control includes a blower coupled to the bladder by a pipework.

20. The system of claim 19 further including a valve disposed in the pipework between the blower and the bladder.

21. The system of claim 15 wherein the bladder is disposed in the controlled atmosphere room.

22. The system of claim 15 further including a gas supply system for selectively supplying gas to the controlled atmosphere room; and
wherein the bladder displacement control configured to return the bladder to a predetermined displacement by reducing the displacement of the bladder while the gas supply system supplies gas to the controlled atmosphere room, the amount of gas supplied the controlled atmosphere room corresponding to the reduction in displacement of the bladder.

23. A method for controlling internal pressure in a controlled atmosphere room, comprising the steps of:
providing a variable-displacement bladder operatively associated with the controlled atmosphere room such that variations in the displacement of the bladder vary the effective volume of the controlled atmosphere room;
determining a differential between an internal pressure within the controlled atmosphere room and an external pressure outside controlled atmosphere room; and
varying the displacement of the bladder based on a differential between the internal pressure and the barometric pressure.

24. The method of claim 23 wherein the variable-displacement bladder is an inflatable bladder; and
wherein the step of varying the displacement of the bladder includes the steps of inflating the bladder to increase the internal pressure and deflating the bladder to decrease the internal pressure.

25. The method of claim 24 wherein the step of inflating the bladder includes the step of operating a blower to supply air the bladder.

26. The method of claim 25 wherein the step of the step of varying the displacement of the bladder includes varying the displacement of the bladder based on a differential between the internal pressure and the barometric pressure to maintain positive internal pressure.

27. The method of claim 23 wherein said determining step includes sensing internal pressure with the controlled atmosphere room and sensing barometric pressure outside the controlled atmosphere room.

28. The method of claim 23 wherein said determining step includes sensing a differential pressure between the internal pressure within the controlled atmosphere room and barometric pressure outside the controlled atmosphere room.
